(19) United States
(12) Patent Application Publication
(10) Pub. No.: US 2021/0314452 A1
(43) Pub. Date: Oct. 7, 2021

(54) COMPOSITE DEVICE, INFORMATION PROCESSOR, LINKING METHOD, AND LINKING PROGRAM

(71) Applicant: KONICA MINOLTA, INC., Tokyo (JP)

(72) Inventor: Hideyuki MATSUDA, Osaka (JP)

(73) Assignee: KONICA MINOLTA, INC., Tokyo (JP)

(21) Appl. No.: 17/178,338

(22) Filed: Feb. 18, 2021

(30) Foreign Application Priority Data
Apr. 2, 2020 (JP) 2020-066990

(51) Int. Cl. H04N 1/00

(52) U.S. Cl. CPC H04N 1/00244; H04N 2201/0039; H04N 2201/0094; H04N 1/00214

(57) ABSTRACT

A composite device includes: a first device that is connected to a network; and a second device that is connected to the network, wherein the first device includes a hardware processor that: acquires device information from a linking candidate device connected to the network; determines whether the linking candidate device from which the device information is acquired is the second device included in the composite device based on the acquired device information; and in a case where the linking candidate device is determined to be the second device, sets to link with the linking candidate device which is determined as the second device.

The entire disclosure of Japanese patent Application No. 2020-066990, filed on Apr. 2, 2020, is incorporated herein by reference in its entirety.

### BACKGROUND

### Technological Field

The present invention relates to a composite device, an information processor, a linking method, and a linking program, and in particular, a composite device including a plurality of devices each connected to a network, an information processor included in the composite device, a linking method executed in the composite device or the information processor, and a linking program causing a computer which controls the composite device or a computer which controls the information processor to execute the linking method.

### Description of the Related art

In recent years, a composite device including an image forming device such as MFP (Multi Function

Peripherals), which is a multifunction digital image forming device, and a server has been known. In this composite device, when the MFP and the server each are connected to the network, it is necessary to identify one from the other on the network. However, the network addresses assigned to the MFP and the server in the network depend on the rules set by the user and should not be fixed.

In Japanese Patent Application Laid-Open No. 2009-181345, it is described a linking system in which, when a remote connection driver of the MFP remotely operates to start an application of the server device, the server device identifies an MFP of which device setting manager has transmitted an operation start signal as a remote operation source device based on the operation start signal transmitted from the MFP, and automatically sets the MFP as an MFP which uses the application.

However, in the linking system described in Japanese Patent Application Laid-Open No. 2009-181345, it is necessary to specify the application of the server device in the MFP in order for the remote connection driver of the MFP to remotely operate the application of the server device. For this reason, the user operating the MFP should enter instructions to identify the application on the server device. Therefore, the user needs to know the information that identifies the server device, and the operation is complicated.

### SUMMARY

The present invention has been made to solve the above-mentioned problems, and one of the objects of the present invention is to provide a composite device that facilitates the operation of linking two devices connected to a network.

Another object of the present invention is to provide an information processor that facilitates the operation of linking two devices connected to a network.

Yet another object of the present invention is to provide a linking method that facilitates the linking operation of two devices connected to a network.

Yet another object of the present invention is to provide a linking program that facilitates the operation of linking two devices connected to a network.

To achieve at least one of the abovementioned objects, according to an aspect of the present invention, a composite device reflecting one aspect of the present invention comprises: a first device that is connected to a network; and a second device that is connected to the network, wherein the first device includes a hardware processor that: acquires device information from a linking candidate device connected to the network; determines whether the linking candidate device from which the device information is acquired is the second device included in the composite device based on the acquired device information; and in a case where the linking candidate device is determined to be the second device, sets to link with the linking candidate device which is determined as the second device.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a perspective view illustrating the appearance of a composite device according to an embodiment of the present invention;

FIG. 2 is a diagram illustrating an example of a network to which the composite device is connected;

FIG. 3 is a block diagram illustrating an example of a hardware configuration of the composite device;

FIG. 4 is a block diagram illustrating an example of a function of a second controller included in a server of the composite device;

FIG. 5 is a block diagram illustrating an example of a function of a first controller included in an MFP of the composite device;

FIG. 6 is a flowchart illustrating an example of a flow of linking process;

FIG. 7 is a flowchart illustrating an example of a flow of initial linking process;

FIG. 8 is a flowchart illustrating an example of a flow of linking setting process; and

FIG. 9 is a flowchart illustrating an example of a flow of device-side linking process.

### DETAILED DESCRIPTION OF EMBODIMENTS

Hereinafter, one or more embodiments of the present invention will be described with reference to the drawings. However, the scope of the invention is not limited to the disclosed embodiments. In the following description, the same parts are designated by the same reference numerals. Their names and functions are also the same. Therefore, detailed explanations about them will not be repeated.

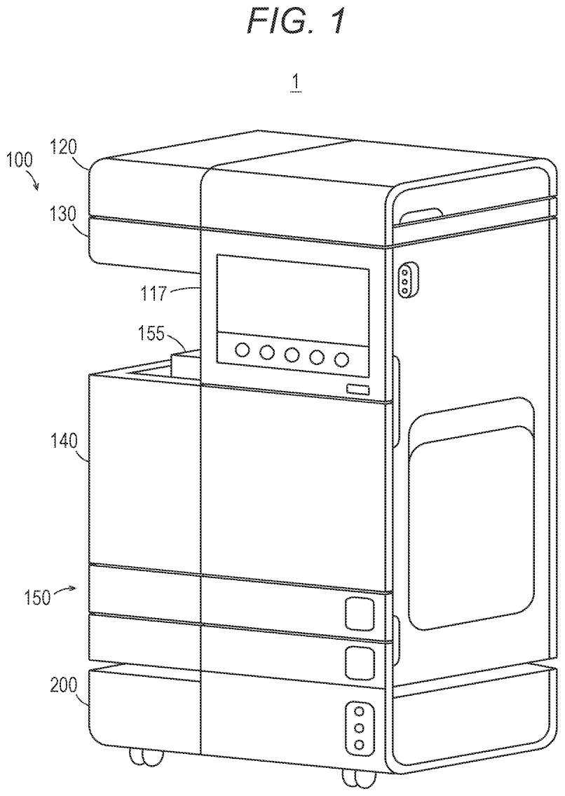

FIG. 1 is a perspective view illustrating the appearance of a composite device according to an embodiment of the present invention. With reference to FIG. 1, a composite device 1 includes an MFP (Multi Function Peripheral) 100 and a server 200 located below the MFP 100.

The MFP 100 is an example of an image forming device, and includes an automatic document conveyor 120, a document reader 130, an image forming unit 140, and a paper feeding unit 150. The automatic document conveyor 120 automatically transports a plurality of document sheets set on a document tray one by one to a document reading position of the document reader 130, and the document reader 130 reads the image formed on the document. The document is ejected to a document ejection tray.

The document reader 130 includes a light source that irradiates light and a photoelectric converter that receives light, and scans an image formed on the document placed on the reading surface. When a document is placed in the reading region, the light emitted from the light source is reflected on the document, and the reflected light is imaged by the photoelectric converter. When the photoelectric converter receives the light reflected on the document, it generates image data obtained by converting the received light into an electric signal.

The paper feeding unit 150 includes two paper feeding trays for accommodating paper. The paper feeding unit 150 conveys the paper stored in either of the two paper feeding trays to the image forming unit 140. The image forming unit 140 forms an image by a well-known electrophotographic method, forms an image on the paper conveyed by the paper feeding unit 150 based on the image data, and ejects the paper with the image formed thereon to a paper ejection tray 155.

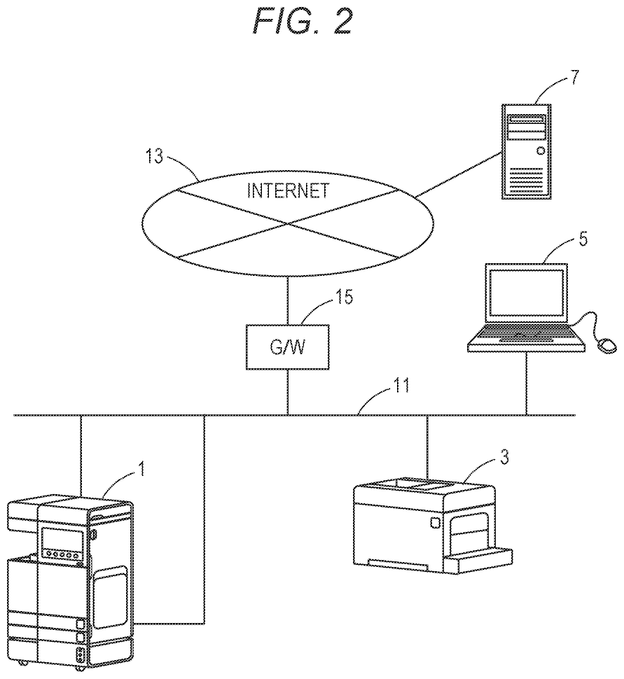

The composite device 1 in the embodiment of the present invention may be used by being connected to a network. FIG. 2 is a diagram illustrating an example of a network to which a composite device is connected. With reference to FIG. 2, the composite device 1 is connected to a LAN (local area network) 11. For example, a printer 3 and a personal computer (PC) 5 are connected to the LAN 11. Further, the LAN 11 is connected to the Internet 13 via a gateway (G/W) 15. Further, an external server 7 is connected to the Internet 13. The PC 5 and the external server 7 is an example of information processor and is a general computer. The composite device 1 can communicate with the printer 3 and the PC 5 via the LAN 11. Further, the composite device 1 can communicate with the external server 7 via the LAN 11, the G/W 15, and the Internet 13.

The composite device 1 has a structure in which the housing of the MFP 100 is stacked on the housing of the server 200, and looks like one housing in appearance. When the composite device 1 is installed, the MFP 100 and the server 200 are installed at the same time. In addition, each of the MFP 100 and the server 200 can be installed independently. Specifically, the server 200 may be installed after the MFP 100 is installed first, and the MFP 100 may be installed after the server 200 is installed first. In either case, the housing of the MFP 100 is stacked on top of the housing of the server 200, making it look like a single housing on appearance.

In addition, the server 200 may be replaced by another server after the composite device 1 is installed. Similarly, after the composite device 1 is installed, the MFP 100 may be replaced by another MFP.

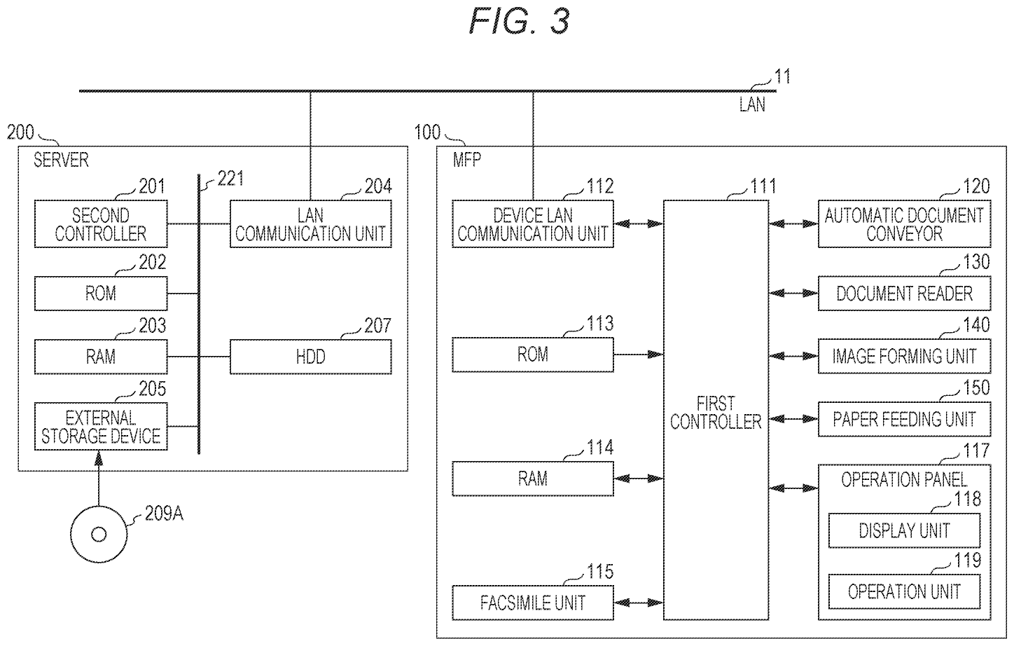

FIG. 3 is a block diagram illustrating an example of the hardware configuration of the composite device. With reference to FIG. 3, the MFP 100 includes a first controller 111, which is a central arithmetic device that controls the entire MFP 100, a device LAN communication unit 112, a ROM (Read Only Memory) 113, and a RAM (Random Access Memory) 114, a facsimile unit 115, the automatic document conveyor 120, the document reader 130, the image forming unit 140, the paper feeding unit 150, and an operation panel 117. The central arithmetic device is a hardware processor.

The first controller 111 is connected to the device LAN communication unit 112, the ROM 113, the RAM 114, the facsimile unit 115, the automatic document conveyor 120, the document reader 130, the image forming unit 140, the paper feeding unit 150, and the operation panel 117, and controls the entire MFP 100.

The ROM 113 stores a program executed by the first controller 111 or data necessary for executing the program. The RAM 114 is used as a work area when the first controller 111 executes a program. Further, the RAM 114 temporarily stores image data continuously sent from the document reader 130.

The operation panel 117 includes a display unit 118 and an operation unit 119. The display unit 118 is, for example, a liquid crystal display (LCD), and displays an instruction menu for the user, information on acquired image data, and the like. If the display unit displays an image instead of the LCD, for example, an organic EL (electroluminescence) display can be used. The operation unit 119 includes a touch panel provided superimposed on the display unit and hard keys.

The facsimile unit 115 is connected to a public switched telephone network (PSTN) and sends facsimile data to or receives facsimile data from the PSTN. The facsimile unit 115 converts the received facsimile data into print data that can be printed by the image forming unit 140, and outputs the print data to the image forming unit 140. As a result, the image forming unit 140 forms an image of the facsimile data received by the facsimile unit 115 on the paper. Further, the facsimile unit 115 converts the image data that the document reader 130 reads the document and converts the outputting image data into facsimile data, and transmits the facsimile data to a facsimile device connected to the PSTN.

The device LAN communication unit 112 is an interface for connecting the first controller 111 to the LAN 11. The device LAN communication unit 112 communicates using a communication protocol such as TCP (Transmission Control Protocol) or UDP (User Datagram Protocol). The connection form of the LAN 11 may be wired or wireless.

The server 200 includes a second controller 201 which is a central arithmetic device that controls the entire server 200, a ROM 202 that stores a program for execution by the second controller 201, a RAM 203 that is used as a work area of the second controller 201, a LAN communication unit 204 that connects the second controller 201 to the LAN 11, an external storage device 205, and a hard disk drive (HDD) 207 that non-volatilely stores the data. The second controller 201, the ROM 202, the RAM 203, the LAN communication unit 204, and the external storage device 205 are connected to a bus 221.

The ROM 202 stores a program executed by the second controller 201 or data necessary for executing the program. The RAM 203 is used as a work area when the second controller 201 executes a program.

The LAN communication unit 204 is an interface for connecting the second controller 201 to the LAN 11. The LAN communication unit 204 communicates using a communication protocol such as TCP or UDP. The connection form of the LAN 11 may be wired or wireless.

The HDD 207 is a large-capacity storage device, and is controlled by the second controller 201. The second controller 201 can read the data stored in the HDD 207 and can write the data to the HDD 207.

The external storage device 205 is controlled by the second controller 201, and is equipped with a CD (Compact Disk)-ROM 209A or a semiconductor memory. The second controller 201 can control the external storage device 205 to read the data stored in the CD-ROM 209A or the semiconductor memory, or write the data to the CD-ROM 209A or the semiconductor memory.

The HDD 207 and the external storage device 205 are set to be shared with the MFP 100 by the second controller 201, and are set by the second controller 201 so as to be accessible from the MFP 100. Therefore, the first controller 111 can read the data stored in the CD-ROM 209A mounted on the HDD 207 or the external storage device 205, and can write the data to them.

The first controller 111 included in the MFP 100 can communicate with the server 200, the printer 3, and the PC 5 connected to the LAN 11 via the LAN 11. In addition, the first controller 111 can communicate with the external server 7 connected to the Internet 13 via the LAN 11 and the G/W 15. Similarly, the second controller 201 included in the server 200 can communicate with the MFP 100, the printer 3, and the PC 5 connected to the LAN 11 via the LAN 11. In addition, the second controller 201 can communicate with the external server 7 connected to the Internet 13 via the LAN 11 and the G/W 15.

In the embodiment of the present invention, an example in which the first controller 111 executes a program stored in the ROM 113 will be described, but the first controller 111 may read a program for execution by the first controller 111 from the CD-ROM 209A or the like mounted on the HDD 207 or the external storage device 205, and load the read program into the RAM 114 and execute the program. Similarly, the second controller 201 may read a program for execution by the second controller 201 from the CD-ROM 209A or the like mounted on the HDD 207 or the external storage device 205, load the read program into the RAM 203, and execute the program.

The recording medium for storing the program to be executed by each of the first controller 111 and the second controller 201 is not limited to the CD-ROM 209A, but may be a medium of a semiconductor memory such as a flexible disc, a cassette tape, an optical disc (MO (Magnetic Optical Disc), MD (Mini Disc)/DVD (Digital Versatile Disc)), IC card, optical card, mask ROM, or EPROM (Erasable Programmable ROM).

Further, the first controller 111 or the second controller 201 may download the program from the computer connected to the LAN 11 or the Internet 13 and store it in the HDD 207, or the computer connected to the LAN 11 or the Internet 13 may write the program in the HDD 207. In this case, the first controller 111 loads the program stored in the HDD 207 into the RAM 114 and executes it, and the second controller 201 loads the program stored in the HDD 207 into the RAM 203 and executes it. The program referred to here includes not only a program that can be directly executed by the first controller 111 or the second controller 201, but also a source program, a compressed program, an encrypted program, and the like.

In the composite device 1 in the embodiment of the present invention, the server 200 has a Web server function, and the MFP 100 has a client function. The second controller 201 executes a Web server program for functioning as a server, and the first controller 111 executes a browsing program for functioning as a client. Specifically, the second controller 201 transmits a Web page including a screen for controlling the server 200 to the MFP 100, and the MFP 100 displays the Web page on the display unit 118. When the user looks at the screen displayed on the display unit 118 and inputs a predetermined operation to the operation unit 119, the task of executing the browsing program sends the operation input by the user to the server 200. The second controller 201 included in the server 200 executes the process according to the operation received from the MFP 100. The process executed by the second controller 201 included in the server 200 includes, for example, a process of storing image data read by the MFP 100 and a process of setting a predetermined set value in the server 200. In this way, the MFP 100 and the server 200 may cooperate to execute the process.

The server 200 and the MFP 100 are each connected to the LAN 11. In the LAN 11, network addresses assigned to each of the server 200 and the MFP 100 are assigned by a DHCP (Dynamic Host Configuration Protocol) server, for example, when the DHCP server is connected to the LAN 11. In this way, fixed IP addresses are not always set for the server 200 and the MFP 100. On the other hand, there are unique values for each of the server 200 and the MFP 100.

In the composite device 1 of the embodiment of the present invention, when the server 200 and the MFP 100 are set to cooperate with each other, a unique value for identifying the other device is set in one of the devices. When two devices are set to cooperate with each other, one device cooperates with the other device based on the unique value of the other device set in the own device, and the other device cooperates with the one device based on the unique value of the own device set in the one device. Further, in the composite device 1, when the server 200 and the MFP 100 are not set in linkage with each other, a unique value for identifying the other device is not set in any of the devices. The unique value is a static value, not a dynamically changing value such as an IP address. The unique value is, for example, a serial number assigned to the device, a UUID (Universally Unique Identifier), a MAC (Media Access Control) address, and a character string indicating a name.

In the following description, in the composite device 1, a case where a unique value for identifying the server 200 is set in the MFP 100 when the server 200 and the MFP 100 are set to cooperate with each other will be described as an example.

Specifically, the MFP 100 stores the linking setting information. The linking setting information is also called device information. The linking setting information is device identification information for identifying the linking device to be linked with the own device. Therefore, in the state where the server 200 and the MFP 100 are set to cooperate, the linking setting information stored in the MFP 100 includes the device identification information of the server 200 which is the linking device. The device identification information is, for example, a serial number assigned to the linking device, a UUID (Universally Unique Identifier), a MAC (Media Access Control) address, or a character string indicating a name.

In the embodiment of the present invention, the linking setting information is set as a part of the MIB (Management Information Base) information. Specifically, the linking setting information is set as an object ID of the MIB information as the object of sysLocation. Nothing is set in the linking setting information of the MFP 100 when the MFP 100 is not linked with any other device. The MFP 100 is linked with the server 200 only after the MFP 100 and the server 200 are connected to the LAN 11. Therefore, before the MFP 100 and the server 200 are connected to the LAN 11, the linking setting information of the MFP 100 indicates that it does not link with any of the other devices. Specifically, the object ID of the MIB information of the MFP 100 is set to Null as the object of sysLocation before the MFP 100 and the server 200 are connected to the LAN 11. In addition, instead of Null, information indicating that it is not linked with any other device may be set.

The object of the MIB information is not limited to these, and any object may be used. Further, the linking setting information is not limited to the MIB information, and information predetermined between the server 200 and the MFP 100 may be used.

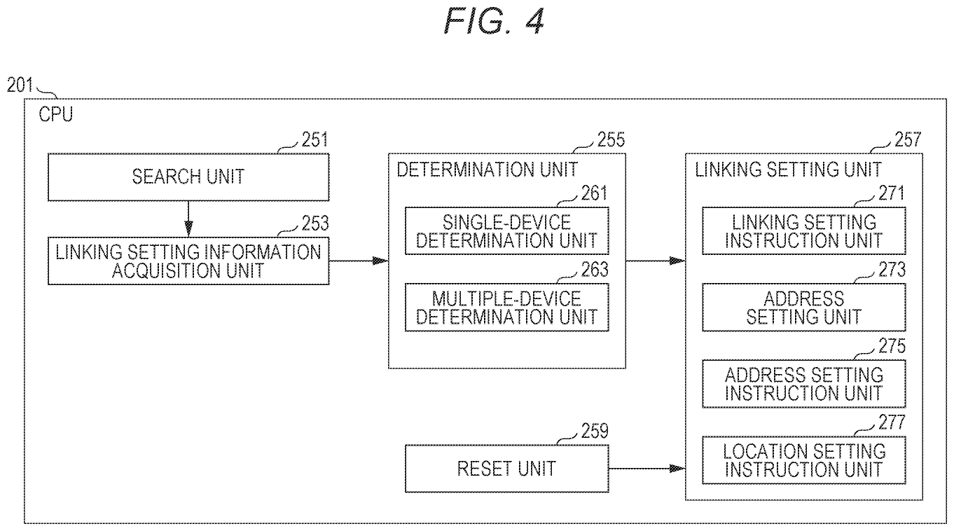

FIG. 4 is a block diagram illustrating an example of the functions of the second controller included in the server of the composite device. The function illustrated in FIG. 4 is a function realized in the second controller 201 when the second controller 201 executes a linking program. With reference to FIG. 4, the second controller 201 includes a search unit 251 that searches for a device connected to the LAN 11, and a linking setting information acquisition unit 253 that acquires linking setting information from the device detected by the search unit 251, a determination unit 255 that determines whether the device searched based on the linking setting information is the linking target device to be linked, a linking setting unit 257 that sets for linkage with the device determined as the linking target device in a case where the device is determined as the linking target device, and a resetting unit 259.

The search unit 251 transmits a search command by broadcasting. The search command is, for example, an ARP (Address Resolution Protocol) request command based on ARP or/and a ping command of ICMP (Internet Control Message Protocol). The search command may be transmitted by multicast. Hereinafter, the device detected by the search unit 251 is referred to as a detection device. Further, another device in which one device is set to cooperate is called a linking device.

The search unit 251 transmits the search command for detecting a device connected to the LAN 11 in a case where the power of the server 200 is turned ON or a case where a predetermined operation is input by the user and a linking device is not registered. Since each of the MFP 100, the printer 3, the PC 5, and the G/W 15 connected to the LAN 11 responds to the search command, the search unit 251 detects the MFP 100, the printer 3, the PC 5, and the G/W 15. The search unit 251 outputs the detected IP addresses of the MFP 100, the printer 3, the PC 5, and the G/W 15 to the linking setting information acquisition unit 253.

The search unit 251 determines that the linking device is registered when the IP address of the linking device is set by the linking setting unit 257 described later, and determines that the linking device is not registered when the IP address of the linking device is not set. A case where a predetermined operation is input by the user is, for example, a case where a serviceman connects a terminal to the server 200 by a USB (Universal Serial Bus) cable and the like and inputs a command to instruct a search from the terminal. The search unit 251 may transmit the search command when the power of the server 200 is turned ON or when a predetermined operation is input by the user even in a case where the linking device is not registered.

The linking setting information acquisition unit 253 acquires linking information from each of the devices detected by the search unit 251. The linking information includes device type information and linking setting information. Specifically, the linking setting information acquisition unit 253 acquires MIB information from the detection device in accordance with SNMP (Simple Network Management Protocol). Specifically, the linking setting information acquisition unit 253 acquires an object whose MIB information object ID (OID) is sysDescr as device type information, and acquires an object whose MIB information object ID is sysLocation as linking setting information. The device type information is information for identifying the device type of the own device. The device type is information indicating the type of device such as a printer, a multifunction device, a facsimile, a gateway, and a hub. The device type may be, for example, a product number for identifying the model of the device. The type of device is specified by referring to a table in which the product number is associated with the type of device. The linking setting information is also referred to as device information, and the linking setting information acquisition unit 253 is also referred to as a device information acquisition unit for acquiring device information which is linking setting information.

The linking setting information acquisition unit 253 extracts a linking candidate device from the devices detected by the search unit 251, here, the MFP 100, the printer 3, the PC 5, and the G/W 15, based on the device type information. The linking setting information acquisition unit 253 outputs the IP address of the linking candidate device to the determination unit 255. The linking candidate device is a device that is a candidate for the server 200 to be linked. The type of device with which the server 200 is linked is predetermined. Here, the device to be linked with the server 200 is a multifunction device. The linking setting information acquisition unit 253 determines a device whose device type information acquired from each device detected by the search unit 251 indicates the type of the multifunction device as the linking candidate device. Therefore, the linking setting information acquisition unit 253 extracts the MFP 100 as a linking candidate device and outputs the IP address of the MFP 100 to the determination unit 255.

In the determination unit 255, the IP address of the linking candidate device is input from the linking setting information acquisition unit 253. When there are a plurality of linking candidate devices, the IP address of each of the plurality of linking candidate devices is input. The determination unit 255 determines whether the linking candidate device is a linking target device to be linked based on the linking setting information of the linking candidate device. Here, the linking target device is the MFP 100 that is integrally combined with the server 200.

The determination unit 255 includes a single-device determination unit 261 and a multiple-device determination unit 263. The single-device determination unit 261 sets the linking candidate device as the linking target device when the linking candidate device is single, and when nothing is set in the linking setting information acquired from the linking target device, the single-device determination unit 261 outputs an initial link instruction to the linking setting unit 257. The initial link instruction includes the IP address of the linking target device. The linking target device is a device to which the server 200 is to be linked, and here, it is the MFP 100. This applies a case where the server 200 and the MFP 100 are installed at the same time, a case where the MFP 100 is installed after the server 200 is installed, and a case where the server 200 and another MFP are linked and the MFP is replaced with another MFP 100. In either case, the object ID of the MIB information of the MFP 100 is set to a value indicating that nothing is set in the object of sysLocation. A value indicating that nothing is set is, for example, Null.

When the device identification information is set in the linking setting information, the single-device determination unit 261 outputs a continuous link instruction to the linking setting unit 257 if the device identification information specifies the own device. The continuous link instruction includes the IP address of the linking target device. This applies when the power of the server 200 is turned off and then turned on. When the device identification information is set in the linking setting information, the single-device determination unit 261 does not output anything to the linking setting unit 257 if the device identification information does not specify the own device.

When there are a plurality of linking candidate devices, and when all of the plurality of pieces of linking setting information acquired from each of the plurality of linking candidate devices do not include the device identification information of the server 200, and there is one piece of linking setting information in which nothing is set among the plurality of pieces of linking setting information, the multiple-device determination unit 263 determines the linking candidate device transmitted the linking setting information with nothing set as a linking target device, and outputs an initial link instruction to the linking setting unit 257. The initial link instruction includes the IP address of the linking target device. The linking target device is a device to which the server 200 is to be linked, and here, it is the MFP 100. This applies a case where the server 200 and the MFP 100 are installed at the same time, a case where the MFP 100 is installed after the server 200 is installed, and a case where the server 200 and another MFP are linked and the MFP is replaced with another MFP 100.

When there are a plurality of linking candidate devices, and the device identification information of the server 200 is set among the plurality of pieces of linking setting information acquired from each of the plurality of the linking candidate devices, the multiple-device determination unit 263 determines the linking candidate device in which the device identification information of the server 200 is set in the linking setting information among the plurality of linking candidate devices as a linking target device, and outputs the continuous link instruction to the linking setting unit 257. The continuous link instruction includes the IP address of the linking target device. This applies when the power of the server 200 is turned off and then turned on.

When there are a plurality of linking candidate devices, and when all of the plurality of pieces of linking setting information acquired from each of the plurality of linking candidate devices do not include the device identification information of the server 200, and there are a plurality of pieces of linking setting information in which nothing is set in the plurality of pieces of linking setting information, the multiple-device determination unit 263 determines that none of the plurality of linking candidate devices is a linking target device, and outputs nothing to the linking setting unit 257.

The linking setting unit 257 is set to be linked with the linking target device determined by the determination unit 255. The linking setting unit 257 includes a linking setting instruction unit 271, an address setting unit 273, an address setting instruction unit 275, and a location setting instruction unit 277.

When the initial link instruction is input from the determination unit 255, the linking setting instruction unit 271 transmits a linking setting instruction to the linking target device. The linking setting instruction includes a command to set the linking setting information including the device identification information for identifying the server 200 to the object whose object ID of the MIB information is sysLocation.

When the initial link instruction or the continuous link instruction is input from the determination unit 255, the address setting unit 273 sets the IP address assigned to the linking target device as the IP address of the linking device with which the server 200 is linked.

When the initial link instruction or the continuous link instruction is input from the determination unit 255, the address setting instruction unit 275 transmits an address setting instruction to the linking target device. The address setting instruction includes a command for setting the IP address of the server 200 as the IP address of the linking device.

When the initial link instruction or the continuous link instruction is input from the determination unit 255, the location setting instruction unit 277 transmits a location setting instruction to the linking target device. The location setting instruction includes a command for setting the location information in the LAN 11 indicating the position of a predetermined storage area of the HDD 207 or predetermined data stored in the HDD 207. The location information is a storage area or a network address of data accessed from the linking target device side in order for the server 200 and the linking target device to perform processing in linkage with each other. The location information is, for example, a URL (Uniform Resource Locator). As an example of the location information, the storage area of the HDD 207 is illustrated as the data storage destination of the linking target device. In addition, the location information indicates the file name of a Web page including the screen for controlling the server 200 that functions as a Web server.

The resetting unit 259 outputs a first reset instruction to the linking setting unit 257 in response to receiving the power ON notification indicating that the power has been turned on from the linking device. The first reset instruction includes the IP address of the linking device that has sent the power ON notification. The power of the linking device may be turned off after the linkage with the server 200 is completed. In this case, the IP address assigned to the linking device may be changed. Since the power of the server 200 is not turned off, the IP address assigned to the server 200 is not changed. When the power is turned on after the power is turned off, the linking device sends the power ON notification to the server 200 of the linking destination. Therefore, when the first reset instruction is output, it is a case where the IP address of the server 200 is not changed, but the IP address of the linking device may be changed.

The address setting unit 273 of the linking setting unit 257 updates the IP address registered as the IP address of the linking device to the IP address included in the first reset instruction in response to the input of the first reset instruction.

Further, the resetting unit 259 outputs a second reset instruction to the linking setting unit 257 when the power of the server 200 is turned on and the linking device is registered. The resetting unit 259 determines that the linking device is registered when the IP address of the linking device is set. The second reset instruction is the IP address of the linking device set by the address setting unit 273.

The address setting instruction unit 275 of the linking setting unit 257 transmits the address setting instruction to the linking device to which the IP address included in the second reset instruction is assigned in response to the input of the second reset instruction. The address setting instruction includes a command to set the IP address assigned to the server 200 as the IP address of the linking device after the power of the server 200 is turned on.

In addition, the location setting instruction unit 277 of the linking setting unit 257 transmits the location setting instruction to the linking device to which the IP address included in the second reset instruction is assigned in response to the input of the second reset instruction. The location setting instruction includes a command for setting the location information in the LAN 11 indicating the position of a predetermined storage area of the HDD 207 or predetermined data stored in the HDD 207.

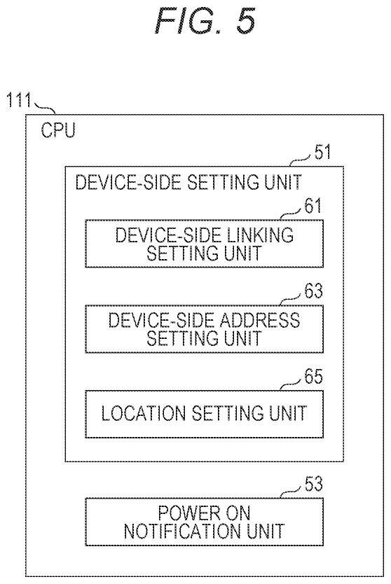

FIG. 5 is a block diagram illustrating an example of the functions of the first controller included in the MFP of the composite device. The function illustrated in FIG. 5 is a function realized by the first controller 111 when the first controller 111 executes a device-side linking program. The device-side linking program is a part of the linking program.

With reference to FIG. 5, the first controller 111 included in the MFP 100 includes a device-side setting unit 51 and a power ON notification unit 53. The device-side setting unit 51 includes a device-side linking setting unit 61, a device-side address setting unit 63, and a location setting unit 65. The device-side linking setting unit 61 sets the server 200 as the linking device in response to receiving the linking setting instruction from the server 200. Specifically, the device identification information for identifying the server 200 included in the linking setting instruction is set in the object whose object ID of the MIB information is sysLocation as the linking setting information.

The device-side address setting unit 63 sets the IP address of the server 200 as the IP address of the linking device in response to receiving the address setting instruction from the server 200.

The location setting unit 65 sets the location information in response to receiving the location setting instruction from the server 200. Specifically, the device-side address setting unit 63 sets the storage area of the HDD 207 as a storage destination of the image data acquired by the MFP 100 reading the document by the document reader 130. The location setting unit 65 adds a button associated with the URL of the Web page including the screen for controlling the server 200 that functions as the Web server to the menu screen.

The power ON notification unit 53 transmits a power ON notification to the server 200 when the server 200 is set as the linking device by the device-side linking setting unit 61 in response to the power of the MFP 100 being turned ON. The power ON notification unit 53 transmits a power ON notification using the IP address of the server 200 set by the device-side address setting unit 63.

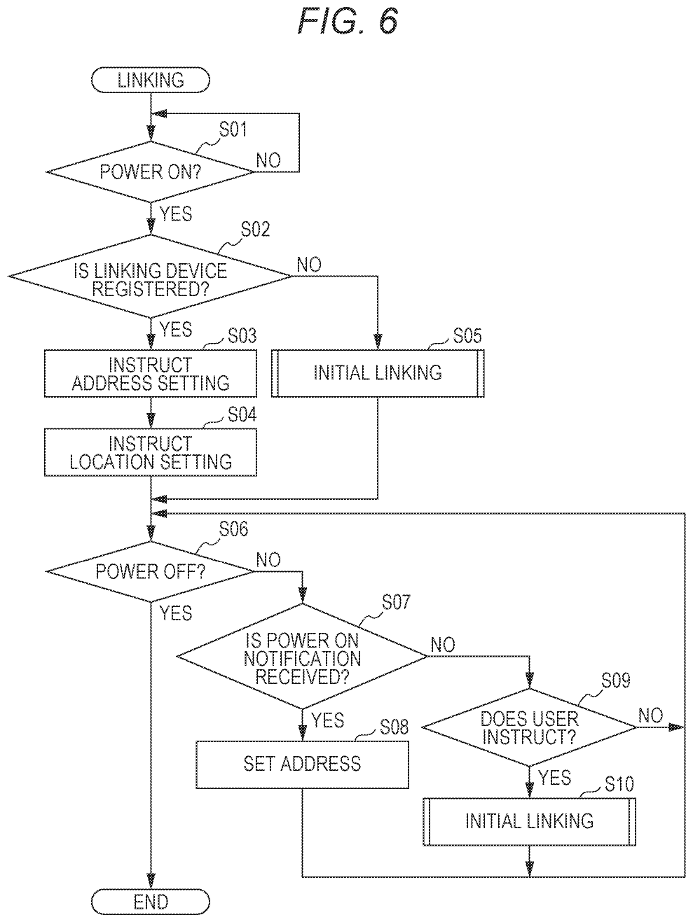

FIG. 6 is a flowchart illustrating an example of a flow of linking process. The linking process is a process executed by the second controller 201 when the second controller 201 included in the server 200 executes the linking program. With reference to FIG. 6, the second controller 201 determines whether the power has been turned on (Step S01). The process is in a standby state until the power is turned on (NO in Step S01), and proceeds to Step S02 if the power is turned on (YES in Step S01).

In Step S02, it is determined whether the linking device is registered. Since the IP address of the linking device is registered by the initial linking process described later, it is determined whether the IP address of the linking device is registered. If the IP address of the linking device is registered, the process proceeds to Step S03, but if not, the process proceeds to Step S05. In Step S05, the initial linking process is executed, and the process proceeds to Step S06.

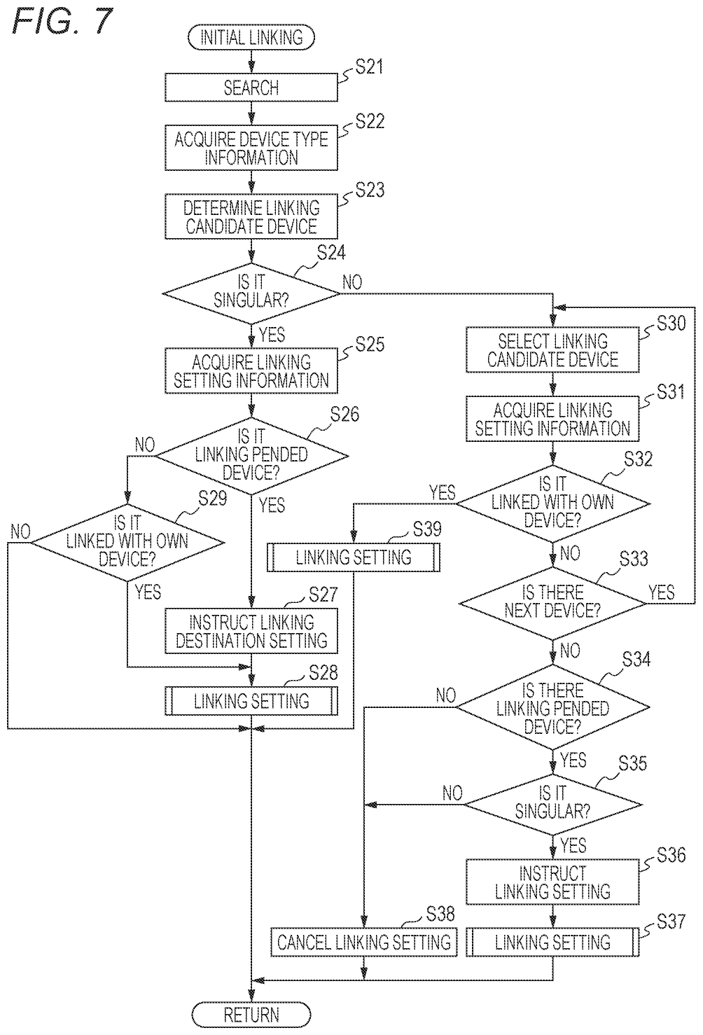

FIG. 7 is a flowchart illustrating an example of a flow of initial linking process. With reference to FIG. 7, the second controller 201 searches for a device connected to the LAN 11 (Step S21), and the process proceeds to Step S22.

In Step S22, device type information is acquired from the device detected as a result of the search in Step S21. Specifically, among the MIB information, the object whose object ID is sysLocation is acquired as the device type information. Then, the linking candidate device is determined (Step S23), and the process proceeds to Step S24. In Step S24, it is determined whether the number of linking candidate devices is singular. If the number of linking candidate devices is singular, the process proceeds to Step S25, but if not, the process proceeds to Step S30. Here, a case where the MFP 100 is determined as a linking candidate device will be described as an example. This applies a case where the server 200 and the MFP 100 are installed at the same time, a case where the MFP 100 is installed after the server 200 is installed, and a case where the server 200 and another MFP are linked and the MFP is replaced with another MFP 100.

In Step S25, the linking setting information is acquired from the linking candidate device. Specifically, among the MIB information, the object whose object ID is set to sysLocation is acquired from the MFP 100 as the linking setting information.

In the next Step S26, it is determined whether the linking candidate device is a linking pended device.

If the linking candidate device is a linking pended device, the process proceeds to Step S27, but if not, the process proceeds to Step S29. If nothing is set in the linking setting information acquired from the linking candidate device, the linking candidate device is determined to be a linking pended device. In Step S27, the linking candidate device is determined as a linking target device, the linking setting instruction is transmitted to the MFP 100 which is the linking target device, and the process proceeds to Step S28. The linking setting instruction includes the device identification information for identifying the server 200, and includes a command for setting the device identification information in the MFP 100 which is the linking target device. Specifically, the command is a command for setting the device identification information of the server 200 in the object whose object ID of the MIB information of the MFP 100 is sysLocation. As a result, the device identification information for identifying the server 200 is set in the object whose object ID of the MIB information of the MFP 100 is sysLocation.

In Step S29, it is determined whether the linking target device is linked with the own device. If the device identification information set in the linking setting information identifies the server 200, it is determined that the linking target device is linked with the own device. If the linking target device is linked with the own device, the process proceeds to Step S28, but if not, the process returns to the linking process. In Step S28, the linking setting process is executed, and the process returns to the linking process.

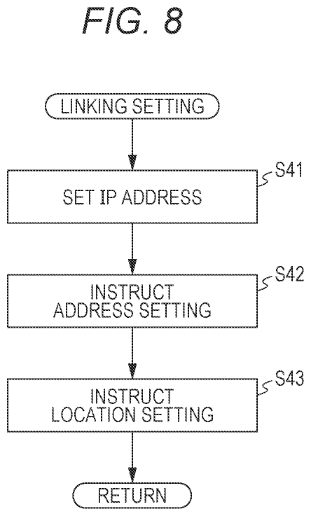

FIG. 8 is a flowchart illustrating an example of a flow of linking setting process. With reference to FIG. 8, the second controller 201 sets the IP address of the MFP 100, which is the linking target device, as the IP address of the linking device (Step S41), and the process proceeds to Step S42.

In Step S42, the address setting instruction is transmitted to the MFP 100 which is the linking target device, and the process proceeds to Step S43. The address setting instruction includes a command for setting the IP address of the server 200 as the IP address of the linking device. Therefore, in the MFP 100 that receives the address setting instruction, the IP address of the server 200 is set as the IP address of the linking device.

In Step S43, the location setting instruction is transmitted to the MFP 100, which is the linking target device, and the process returns to the initial setting process. The location setting instruction includes a command for setting the location information in the LAN 11 indicating the position of a predetermined storage area of the HDD 207 or predetermined data stored in the HDD 207. Therefore, in the MFP 100 that receives the location setting instruction, the storage area of the HDD 207 is set as the storage destination of the image data acquired by the MFP 100 reading the document by the document reader 130. In addition, in the MFP 100, a button associated with the URL of the Web page including the screen for controlling the server 200 that functions as the Web server is added to the menu screen.

Returning to FIG. 7, when the process proceeds to Step S30, it is a case where there are a plurality of linking candidate devices.

In Step S30, one of the processing targets is selected from among the plurality of linking candidate devices, and the process proceeds to Step S31. In Step S31, the linking setting information is acquired from the linking candidate device selected as the processing target, and the process proceeds to Step S32. Specifically, among the MIB information, the object whose object ID is set to sysLocation is acquired from the linking candidate device as the linking setting information.

In Step S32, it is determined whether the linking candidate device is linked with the own device. If the device identification information set in the linking setting information acquired from the linking candidate device identifies the server 200, it is determined that the linking target device is linked with the own device. If the linking candidate device is linked with the own device, the process proceeds to Step S39, but if not, the process proceeds to Step S33. When the process proceeds to Step S39, for example, before the server 200 is newly installed, it is a case where the user sets the server 200 as the linking destination device in the MFP 100. In Step S39, the linking setting process is executed, and the process returns to the linking process.

In Step S33, it is determined whether there is a linking candidate device that has not been selected as the processing target. If there is an unselected linking candidate device, the process returns to Step S30, but if not, the process proceeds to Step S34.

When the process proceeds to Step S34, it is a case where all of the plurality of linking candidate devices are not linked with the own device. In Step S34, it is determined whether there is a linking pended device among the plurality of linking candidate devices. If there is linking setting information in which nothing is set among the plurality of pieces of linking setting information acquired from the plurality of linking candidate devices, it is determined that the linking candidate device that has transmitted the linking setting information is the linking pended device. If there is a linking pended device among the plurality of linking candidate devices, the process proceeds to Step S35, but if not, the process proceeds to Step S38.

In Step S35, it is determined whether the number of linking pended devices is singular. If the number of linking pended devices is singular, the process proceeds to Step S36, but if not, the process proceeds to Step S38. In Step S36, the linking pended device is determined as a linking target device, the linking setting instruction is transmitted to the linking target device, and the process proceeds to Step S37. In Step S37, the linking setting process is executed, and the process returns to the linking process. In Step S38, the linkage setting is canceled, and the process returns to the linking process. Specifically, the IP address of the device at the linking destination is deleted.

Returning to FIG. 6, if it is determined in Step S01 that the power has been turned on and it is determined in Step S02 that the linking device is registered, the process proceeds to Step S03. Here, the case where the IP address of the MFP 100 is registered as the IP address of the linking device will be described as an example.

In Step S03, the address setting instruction is transmitted to the MFP 100 which is the linking device, and the process proceeds to Step S04. The address setting instruction includes a command for setting the IP address of the server 200 as the IP address of the linking device. Therefore, in the MFP 100 that receives the address setting instruction, the IP address of the server 200 is set as the IP address of the linking device.

In Step S04, the location setting instruction is transmitted to the MFP 100 which is the linking device, and the process proceeds to Step S06. The location setting instruction includes a command for setting the location information in the LAN 11 indicating the position of a predetermined storage area of the HDD 207 or predetermined data stored in the HDD 207. Therefore, in the MFP 100 that receives the location setting instruction, the storage area of the HDD 207 is set as the storage destination of the image data acquired by the MFP 100 reading the document by the document reader 130. In addition, in the MFP 100, a button associated with the URL of the Web page including the screen for controlling the server 200 that functions as the Web server is added to the menu screen.

In Step S06, it is determined whether the power is turned off. If the power is turned off, the process ends, but if not, the process proceeds to Step S07. In Step S07, it is determined whether the power ON notification has been received from the MFP 100 which is the linking device. If the power ON notification is received, the process proceeds to Step S08, but if not, the process proceeds to Step S09. The device that transmits the power ON notification is a linking device, and here, the MFP 100.

In Step S08, the IP address of the MFP 100 that has transmitted the power ON notification is set as the IP address of the linking device, and the process returns to Step S06. In Step S09, it is determined whether the instruction from the user has been accepted. For example, a serviceman may directly or indirectly connect a terminal to the server 200 to operate the server, and may input an operation instructing the server to execute the linking process. If the operation instructing the execution of the linking process by the user is accepted, the process proceeds to Step S10, but if not, the process returns to Step S06. In Step S10, the initial linking process is executed as in Step S05, and the process returns to Step S06. For example, when the server 200 is linked with the MFP 100 and the MFP 100 is replaced with another MFP, an operation instructing the user to execute the linking process is accepted.

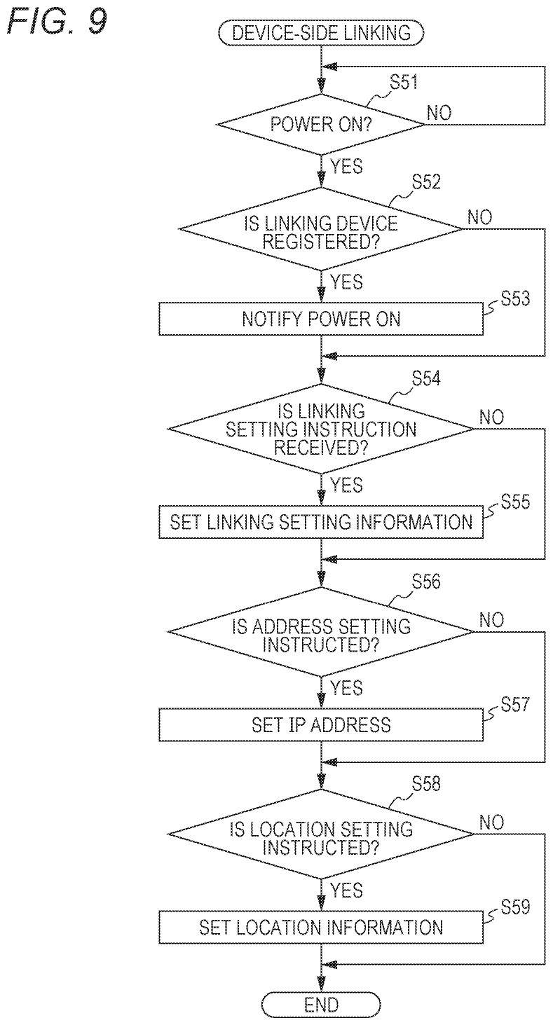

FIG. 9 is a flowchart illustrating an example of a flow of device-side linking process. The device-side linking process is a process executed by the first controller 111 when the first controller 111 included in the MFP 100 executes the device-side linking program.

With reference to FIG. 9, the first controller 111 included in the MFP 100 determines in Step S51 whether the power is turned on. The process is in a standby state until the power is turned on (NO in Step S51), and proceeds to Step S52 if the power is turned on (YES in Step S51). In Step S52, it is determined whether the linking device is registered. In Step S57, which will be described later, it is determined whether the IP address of the server 200, which is the linking device, is set. If the linking device is registered, the process proceeds to Step S53, but if not, the process proceeds to Step S54. In Step S53, the power ON notification is sent to the server 200, and the process proceeds to Step S54.

In Step S54, it is determined whether the linking setting instruction has been received from the server 200. If the linking setting instruction is received, the process proceeds to Step S55, but if not, the process proceeds to Step S56. In Step S55, the device identification information of the server 200 included in the linking setting instruction is set as the linking setting information, and the process proceeds to Step S56. Specifically, the device identification information of the server 200 is set to the object whose object ID of the MIB information is sysLocation.

In Step S56, it is determined whether the address setting instruction has been received from the server 200. If the address setting instruction is received, the process proceeds to Step S57, but if not, the process proceeds to Step S58. In Step S57, the IP address of the server 200 is set as the IP address of the linking device, and the process proceeds to Step S58.

In Step S58, it is determined whether the location setting instruction has been received from the server 200. If the location setting instruction is received, the process proceeds to Step S59, but if not, the process ends. In Step S59, the location information included in the location setting instruction is set. Specifically, the storage area of the HDD 207 is set as the storage destination of the image data acquired by the MFP 100 reading the document by the document reader 130. In addition, a button associated with the URL of the Web page including the screen for controlling the server 200 that functions as the Web server is added to the menu screen.

As described above, the composite device 1 in the embodiment of the present invention includes the server 200 and the MFP 100, each of which is connected to the LAN 11, and the linking setting information indicating that no device is linked before the server 200 and the MFP 100 are connected to the LAN 11 is set in the MFP 100. Based on the device type information acquired from the device connected to the LAN 11, the server 200 extracts the linking target device of the multifunction device having the same device type as the MFP 100 from the devices connected to the LAN 11. Then, when the linking setting information is acquired from the linking candidate device and the linking setting information indicates that no device is linked, the linking candidate device connected to the LAN 11 is determined to be the MFP 100. When the linking candidate device connected to the LAN 11 is determined to be the MFP 100, the setting for linking with the linking candidate device determined to be the MFP 100 is made. Therefore, two devices can be linked while the server 200 and the MFP 100 are connected to the LAN 11.

In addition, the server 200 searches for a device connected to the LAN 11. In a case where a single linking candidate device is detected by the search, and the linking setting information acquired from the detected linking candidate device indicates that no device is linked, the server 200 determines the linking candidate device to be the MFP 100. Therefore, if one of the server 200 and the MFP 100 is connected to the LAN 11 and the other is connected to the LAN 11, the server 200 and the MFP 100 can be linked.

Further, the server 200 searches for a device connected to the LAN 11. In a case where a plurality of linking candidate devices are detected by the search, and none of the plurality of detected linking candidate devices is linked with the server 200, and there is a single linking candidate device with which none of the plurality of detected linking candidate devices is linked, the server 200 determines the single linking candidate device that is not linked with any other device to be the MFP 100. Therefore, if one of the server 200 and the MFP 100 and a plurality of other devices are connected to the LAN 11, and the other device is connected to the LAN 11, the server 200 and the MFP 100 can be linked.

Further, the server 200 sets the device identification information for identifying the server 200 in the MFP 100 as the linking setting information. Therefore, it is not necessary for the server 200 to set the linking of the server 200 and the MFP 100, so that the management is easy.

Further, the device identification information is information different from the network address. Therefore, even if the network address is changed, the linking between the server 200 and the MFP 100 can be maintained.

Further, the server 200 determines that the device connected to the LAN 11 is the MFP 100 when the device identification information for identifying the server 200 is set as the linking setting information in the device connected to the LAN 11. Therefore, the linking between the server 200 and the MFP 100 can be maintained.

Further, the server 200 causes the MFP 100 to set the network address of the server 200, and sets the network address of the MFP 100. Therefore, even if the network addresses of the server 200 and the MFP 100 are changed, the server 200 and the MFP 100 can communicate with each other.

Further, when the server 200 is restarted after being linked with the MFP 100, the server 200 sets the network address newly assigned to the server 200 to the MFP 100. Therefore, after the server 200 is restarted, communication can be performed between the server 200 and the MFP 100.

Further, the server 200 further includes the HDD 207, and sets the location information including the network address in the LAN 11 of the predetermined storage area of the HDD 207 or the Web page data stored in the HDD 207 in the MFP 100. Therefore, the server 200 can be controlled from the MFP 100.

Further, when the server 200 is restarted after being linked with the MFP 100, the server 200 sets the location information in the MEP 100 by using the network address of the MFP 100 set by the linking with the MFP 100. Therefore, when the server 200 is restarted after linking with the MFP 100, the server 200 can be controlled from the MFP 100.

In addition, when the MFP 100 restarts after linking with the server 200, the MFP 100 notifies the server 200 that it has started using the network address of the server 200 set by linking with the server 200. When receiving the notification from the MFP 100, the server 200 updates the network address of the MFP 100, which is set by the linking with the MFP 100, with the network address newly assigned to the MFP 100. Therefore, when the MFP 100 is restarted after linking with the server 200, communication between the server 200 and the MFP 100 becomes possible.

Further, the linking setting information is a value set in a predetermined area of the MIB information. Therefore, the linking setting information can be easily acquired.

Further, when the server 200 acquires the linking setting information from the linking candidate device connected to the LAN 11 and the linking setting information indicates that no device is linked, the server 200 determines that the linking candidate device is the linking target device and sets for linking with the linking target device. Therefore, two devices can be linked while the server 200 and the MFP 100 are connected to the network.

In addition, the server 200 searches for the linking candidate device. In a case where the linking candidate device detected by the search is one, and the linking setting information acquired from the detected linking candidate device indicates that no device is linked, the server 200 determines the linking candidate device to be the linking target device. Therefore, if one of the server 200 and the MFP 100 is connected to the LAN 11 and the other is connected to the LAN 11, the server 200 and the MFP 100 can be linked.

Further, the server 200 searches for a linking candidate device. In a case where there are a plurality of linking candidate devices detected by the search and none of the plurality of detected linking candidate devices is linked with the server 200, the server 200 determines a single device that is not linked with any of the plurality of linking candidate devices as the linking target device. Therefore, if one of the server 200 and the MFP 100 and a plurality of other devices are connected to the LAN 11, and the other device is connected to the LAN 11, the server 200 and the MFP 100 can be linked.

In the embodiment of the present invention, the server 200 executes the linking process and the MFP 100 executes the device-side linking process. However, the MEP 100 may execute the linking process and the server 200 may execute the device-side linking process. Similarly, although the server 200 has been described as an example of the information processor, the MFP 100 may function as an information processor.

<Notes>

(1) Preferably, device information indicating that the first device and the second device are not linked to any other device is set in the second device before the first device and the second device are connected to the network.

(2) Preferably, in a state where the first device is connected to the network, the search unit searches according to the connection of the second device to the network.

(3) Preferably, in a state where the first device is linked with a device different from the second device, the search unit searches according to the replacement of the other device to the second device.

(4) Preferably, in a state where the second device is connected to the network, the search unit searches according to the connection of the first device to the network.

(5) Preferably, in a state where the second device is linked with a device different from the first device, the search unit searches according to the replacement of the other device to the first device.

(6) Preferably, the device identification information includes at least one of a serial number or UUID (Universally Unique Identifier) assigned to the first device and a character string indicating the first device.

Although embodiments of the present invention have been described and illustrated in detail, the disclosed embodiments are made for purposes of illustration and example only and not limitation. The scope of the present invention should be interpreted not by terms of the description above but by terms of the appended claims, and is intended to include the meanings equivalent to claims and all changes within the scope.

What is claimed is:

1. A composite device, comprising:
a first device that is connected to a network; and
a second device that is connected to the network,
wherein the first device includes
a hardware processor that:
acquires device information from a linking candidate device connected to the network;
determines whether the linking candidate device from which the device information is acquired is the second device included in the composite device based on the acquired device information; and
in a case where the linking candidate device is determined to be the second device, sets to link with the linking candidate device which is determined as the second device.

2. The composite device according to claim 1,
wherein the hardware processor searches a device connected to the network, and
in a case where a single linking candidate device is detected by the hardware processor and the device information acquired from the detected linking candidate device indicates that no device is linked, the hardware processor determines the linking candidate device to be the second device.

3. The composite device according to claim 1,
wherein the hardware processor searches a device connected to the network, and
in a case where a plurality of linking candidate devices are detected by the hardware processor, any of the plurality of detected linking candidate devices is linked with the first device, and there is a single linking candidate device which is not linked with any other devices among the plurality of detected linking candidate devices, the hardware processor determines the single linking candidate device which is not linked with any other devices to be the second device.

4. The composite device according to claim 1,
wherein the hardware processor sets device identification information for identifying the first device in the second device as the device information.

5. The composite device according to claim 4,
wherein the device identification information is information different from a network address.

6. The composite device according to claim 4,
wherein, in a case where the device identification information for identifying the first device is set in a device connected to the network, the hardware processor determines the device connected to the network to be the second device.

7. The composite device according to claim 1,
wherein the hardware processor sets a network address of the first device in the second device, and sets a network address of the second device.

8. The composite device according to claim 7,
wherein, in a case where the first device restarts after being linked with the second device, the hardware processor causes the first device to set a network address newly assigned to the first device in the second device.

9. The composite device according to claim 1,
wherein the first device further includes a storage, and
the hardware processor sets location information, which indicates a location in the network of predetermined data stored in a predetermined storage area of the storage or the storage, in the second device.

10. The composite device according to claim 9,
wherein, in a case where the first device restarts after being linked with the second device, the hardware processor sets the location information in the second device using a network address of the second device set by linking with the second device.

11. The composite device according to claim 1,
wherein the second device further includes the hardware processor that, in a case where the second device restarts after being linked with the first device, notifies the first device of starting using a network address of the first device set by linking with the first device, and
the hardware processor updates a network address of the second device set by linking with the second device with a network address newly assigned to the second device in response to receiving the notification.

12. The composite device according to claim 1,
wherein the device information is a value set in a predetermined area of a MIB (Management Information Base).

13. An information processor, comprising:
a hardware processor that:
acquires linking setting information from a linking candidate device connected to a network;
in a case where the acquired linking setting information indicates that no device is linked, determines that the linking candidate device to be a linking target device; and
sets for linking with the linking target device.

14. The information processor according to claim 13,
wherein the hardware processor searches the linking candidate device, and
in a case where the linking candidate device detected by the hardware processor is one and the linking setting information acquired from the detected linking candidate device indicates that no device is linked, the hardware processor determines the linking candidate device to be the linking target device.

15. The information processor according to claim 13,
wherein the hardware processor searches the linking candidate device, and
in a case where the linking candidate device detected by the hardware processor is plural, and any of the plurality of detected linking candidate devices is not linked with the own device, the hardware processor determines a single device, which is not linked with any other devices among the plurality of detected linking candidate devices, as the linking target device.

16. A linking method that is executed by a composite device which includes a second device and a first device, each of which is connected to a network,
wherein the first device is caused to execute:
acquiring device information from a device connected to the network;
determining whether a linking candidate device from which the device information is acquired is the second device included in the composite device based on the acquired device information; and
setting for linking with the second device in a case where the device connected to the network is determined to be the second device.

17. A linking method that causes an information processor to execute:
acquiring linking setting information from a linking candidate device connected to a network;
determining, in a case where the acquired linking setting information indicates linking with any other device, the linking candidate device to be a linking target device; and
setting for linking with the linking target device.

18. A non-transitory recording medium storing a computer readable linking program that is executed by a composite device which includes a second device and a first device, each of which is connected to a network,
wherein a computer that controls the first device is caused to execute:
acquiring device information from a device connected to the network;
determining whether a linking candidate device from which the device information is acquired is the second device included in the composite device based on the acquired device information; and
setting for linking with the second device in a case where the device connected to the network is determined to be the second device.

19. A non-transitory recording medium storing a computer readable linking program that causes a computer which controls an information processor to execute:
acquiring linking setting information from a linking candidate device connected to a network;
determining, in a case where the acquired linking setting information indicates linking with any other device, the linking candidate device to be a linking target device; and
setting for linking with the linking target device.
